(19) United States
(12) Patent Application Publication
(10) Pub. No.: US 2025/0085388 A1
(43) Pub. Date: Mar. 13, 2025

(54) INTEGRATED RADAR IN WIRELESS LOCAL AREA NETWORK (WLAN) RADIO FOR PRESENCE DETECTION

(71) Applicant: Amazon Technologies, Inc., Seattle, WA (US)

(72) Inventors: Durga Laxmi Narayana Swamy Inti, San Jose, CA (US); Maqsood Ahamed Abdul Careem, Sunnyvale, CA (US); Ravi Ichapurapu, Morgan Hill, CA (US); Shruti Makharia, Los Gatos, CA (US)

(21) Appl. No.: 18/244,825

(22) Filed: Sep. 11, 2023

(51) Int. Cl. G01S 7/35; G01S 7/00; G01S 13/536; G01S 13/56

(52) U.S. Cl. CPC G01S 7/358; G01S 7/006; G01S 13/536; G01S 13/56

(57) ABSTRACT

Technologies directed to providing a wireless chipset with integrated radar for presence detection and localization for natural and ambient interactions with a device are described. A wireless device can send via a first antenna, a set of chirps in a first portion of a frame. The wireless device can receive, via a second antenna, reflected signals corresponding to the set of chirps, and generate in-phase and quadrature (IQ) samples. The wireless device sends (or receives), data in a second portion of the frame to (or from) a second device. The wireless device generates, using RF signals sent or received by the wireless device, channel state information (CSI) data representing channel properties of a channel. The wireless device can determine, using the IQ samples and the CSI data, that an environment in which the wireless device is located has been disrupted by a presence or motion of a person.

### BACKGROUND

A large and growing population of users is enjoying entertainment through the consumption of digital media items, such as music, movies, images, electronic books, and so on. The users employ various electronic devices to consume such media items. Among these electronic devices (referred to herein as endpoint devices, user devices, clients, client devices, or user equipment) are electronic book readers, cellular telephones, personal digital assistants (PDAs), portable media players, tablet computers, netbooks, laptops, and the like. These electronic devices wirelessly communicate with a communications infrastructure to enable the consumption of digital media items. These electronic devices include one or more antennas to wirelessly communicate with other devices.

### BRIEF DESCRIPTION OF DRAWINGS

The present inventions will be understood more fully from the detailed description given below and from the accompanying drawings of various embodiments of the present invention, which, however, should not be taken to limit the present invention to the specific embodiments, but are for explanation and understanding only.

FIG. 1 is a block diagram of a wireless device with a baseband processor with integrated radio and radar functionality according to at least one embodiment.

FIG. 2 is a flow diagram of a method of operating a baseband processor in a radar mode and a radio mode according to at least one embodiment.

FIG. 3 illustrates a frame in which a wireless device switches between a radar mode and a radio mode according to at least one embodiment.

FIG. 4 is a flow diagram illustrating a method by a host processor to collect in-phase and quadrature (IQ) samples and channel state information (CSI) data for presence detection according to at least one embodiment.

FIG. 5 illustrates a method in accordance with one embodiment.

FIG. 6 is a block diagram of a wireless device with 600 with integrated radio and radar functionality according to one embodiment.

### DETAILED DESCRIPTION

Technologies directed to providing a wireless chipset with integrated radar for presence detection and localization for natural and ambient interactions with a device are described. Ambient mode, in the context of consumer electronic devices, refers to a feature that allows a device, such as a smartphone, tablet, smart TV, or smart display, to display useful or decorative information when it is not actively in use or when it is in a standby mode. This feature is designed to provide users with glanceable and visually appealing content without interacting with the device directly. Ambient mode serves as a way to enhance the user experience and make the device more functional and visually engaging even when it is not being actively used for its primary purpose. Some ambient mode features can be integrated with other smart devices or services in a user's ecosystem. For example, a smart display might show upcoming appointments from the user's calendar or control smart home devices like lights and thermostats. TVs in ambient mode can show a screensaver-like display with time, weather, news headlines, and even display photos from the user's gallery. The ambient mode aims to improve user experience by enabling features like automatic TV on/off, dynamic art, or the like when the user's presence or motion is detected.

Conventionally, the ambient mode requires new hardware, such as a mmWave radar unit or an Ambient Light Sensor (ALS) that can be expensive and unavailable on various products. Incorporating this hardware increases the cost of the products, such as smart TVs. There are many products that lack this hardware but could benefit from the ambient mode. However, the cost of the standalone mmWave radar solutions is one of the primary bottlenecks for not scaling radar to lower-costing products. There have been some conventional approaches for presence and motion sensing, such as ultrasound presence detection (USPD) and Wi-Fi® Channel State Information (CSI) based sensing. However, the USPD cannot be enabled on products without a speaker and a microphone array for operation. USPD primarily serves as a motion detector and does not handle static presence. CSI-based sensing does not require additional hardware and can work on any Wi-Fi-enabled device. However, to enable ambient experience on devices with Wi-Fi® CSI alone, there can be significant drawbacks. CSI-sensing solutions can detect false positives caused by inanimate objects. CSI-sensing solutions do not provide location information and cannot be used for room-level detection with a single device as it is impossible to identify a side of a link (i.e., Access Point (AP) side or device side) where motion happened.

Aspects and embodiments of the present disclosure overcome these deficiencies and others by providing an integrated radar (e.g., frequency modulated continuous wave (FMCW) radar unit) in a wireless chipset, such as one that implements the Wi-Fi® and/or Bluetooth® technologies (hereinafter wireless chipset). The integrated radar in the wireless chipset re-uses the Wi-Fi®/Bluetooth® transmit chain for radar transmissions for sending chirps and a dedicated RX chain for receiving reflected signals from the chirps for the presence and localization of a user. A chirp, also referred to as a chirp signal, is a specific type of signal. A chirp is characterized by its frequency that changes over time. It starts at a specific frequency and either increases or decreases linearly as time progresses. The device can use in-phase and quadrature (IQ) samples from the radar transmissions and CSI data from the radio transmissions to determine that the environment in which the wireless device is located has been disrupted by a presence or motion of a person. Radar capability on the wireless connectivity solution provides a credible presence and location information with minimal additional costs and creates opportunities for sensor fusion with other modalities. The IQ samples from the radar could be a viable alternative for enabling features like ambient and smart modes on various devices. Combining the CSI data with the IQ samples can provide increased coverage of presence/motion detection. The IQ samples and CSI data can be used to distinguish between room-level detection and home-level detection. Aspects and embodiments of the present disclosure can enable low-cost ambient experience on wireless devices using radar integrated on Wi-Fi® chipsets without having the need for any other sensors.

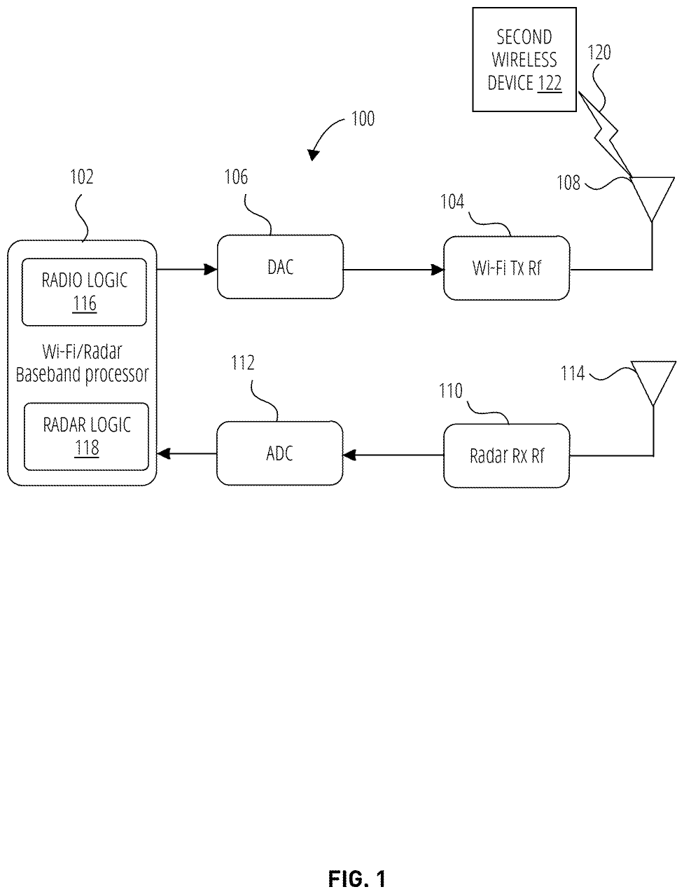

FIG. 1 is a block diagram of a wireless device 100 with a baseband processor 102 with integrated radio and radar functionality according to at least one embodiment. The wireless device 100 includes the baseband processor 102, a TX chain 104, a digital-to-analog converter (DAC) 106, a TX antenna 108, an RX chain 110, an analog-to-digital converter (ADC) 112, and an RX antenna 114. The baseband processor 102 can be a wireless chipset coupled to a host device.

In at least one embodiment, the baseband processor 102 is a System on Chip (SoC) that manages, among other things, the wireless protocol of a radio and possibly other aspects of the behavior and operation of the wireless device 100. The wireless device 100 can also include a host processor that controls the operations of the baseband processor 102 and other operations of the wireless device 100. The baseband processor 102 can control radio operations to communicate with one or more devices over one or more communication links. The baseband processor 102 can implement the Wi-Fi® technology, the Bluetooth® technology, or both. Alternatively, the baseband processor 102 can implement other radio technologies. The baseband processor 102 can be any type of processing device, such as a digital signal processor (DSP), an application-specific integrated circuit (ASIC), a field-programmable gate array, or any other type of processing device with radio functionality. In at least one embodiment, the baseband processor 102 can include radio logic 116 and radar logic 118. The radio logic 116 can be a radio subsystem of the baseband processor 102, and the radar logic 118 can be a radar subsystem of the baseband processor 102.

In at least one embodiment, the baseband processor 102 is coupled to the TX antenna 108. The baseband processor 102 can drive the TX antenna 108 using one or more RF signals in an RF path, including at least the TX chain 104. A current flow on the RF path can induce current on the TX antenna 108 to cause the TX antenna 108 to radiate electromagnetic energy. The baseband processor 102 can also receive RF signals, received as electromagnetic energy by an RX antenna 114, in an RF path, including at least the RX chain 110. The RX chain 110 can be a dedicated path for radar operations, and a separate RX chain can be used for receiving the RF signals. In some cases, the RF signals are received on the same TX antenna 108. The TX antenna 108 and the RX antenna 114 can be any type of antenna, such as a monopole, a loop, a patch, a slot, or the like. The baseband processor 102 can cause the TX antenna 108 and RX antenna 114 to radiate and receive electromagnetic energy in a specified frequency range, such as the 2.4 GHz frequency band for wireless personal area network (WPAN) applications (e.g., Bluetooth® Classic or Bluetooth® Low Energy (BLE) technology), wireless local area network (WLAN) applications (e.g., Wi-Fi® technology), or the like. In one embodiment, an operating frequency of the baseband processor 102 is a wide area network (WAN) frequency band (e.g., 5G, Long Term Evolution (LTE) technology, or the like).

During operation, the baseband processor 102 can establish a wireless connection 120 with a second wireless device 122 over a channel using a wireless local area network (WLAN) protocol (e.g., Wi-Fi® protocol). The radar logic 118 can be a radar unit integrated into the same integrated circuit as the radio logic 116. The radio logic 116 implements the radio functionality of the wireless device 100 for communicating with other wireless devices, including the second wireless device 122. The radar logic 118 implements the radar functionality of the wireless device 100 for presence and localization operations described herein.

In at least one embodiment, the TX chain 104, the DAC 106, the RX chain 110, and the ADC 112 can be part of radio frequency front-end (RFFE) circuitry. The TX chain 104 can include components involved in generating and transmitting radio frequency (RF) signals. The TX chain 104 can be calibrated to ensure accurate and reliable signal transmission. For example, the TX chain 104 can include power amplifiers, filters, and frequency synthesizers. Calibration in the TX chain is essential to ensure accurate and reliable signal transmission. A set of parameters can be determined and used for transmitting and receiving RF signals for RF communications. A different set of parameters can be determined and used for radar functionality, as described in more detail below. The set of parameters can be calibration values for RF front-end calibration, gain and phase calibration, in-phase and quadrature (IQ) imbalance calibration, pre-distortion calibration, carrier frequency calibration, antenna calibration, time alignment calibration, DC offset calibration, temperature compensation, or the like. Calibration in the TX chain 104 is typically performed during a manufacturing process or periodically during operation to maintain system performance over time. It is crucial for meeting regulatory requirements, achieving high-quality communication, and minimizing interference with other wireless systems. Calibration algorithms and methods may vary depending on the specific communication technology and system design.

The RFFE circuitry can include a DAC 106 that can convert digital signals to output analog signals for RF transmissions via the TX antenna 108. Similarly, the RFFE circuitry can include an ADC 112 that can convert input analog signals into digital signals for processing by the baseband processor 102.

In at least one embodiment, since the radar logic 118 is integrated into the baseband processor 102, the TX chain 104 can be reused for radar transmissions. The RX chain 110 can be a dedicated RX chain for receiving reflected signals from the radar transmissions for presence and localization. In particular, the baseband processor 102 can send, via the TX chain 104, a set of chirps in a first portion of a frame having a specified frame duration. The baseband processor 102 can receive, via the RX chain 110, reflected signals corresponding to the set of chirps. The baseband processor 102 can generate IQ samples based on the reflected signals and the set of chirps. The baseband processor 102 can send or receive, via the TX chain 104 or the RX chain 110, first RF signals in a second portion of the frame. The baseband processor 102 can generate channel state information (CSI) data representing channel properties of the channel based on second RF signals sent or received by the RFFE circuitry during a specified interval. The second RF signals can include the first RF signals sent in the second portion of the frame.

In at least one embodiment, the wireless device 100 includes a host processor coupled to the baseband processor 102 (not illustrated in FIG. 1). The host processor can receive the IQ samples from the radar logic 118 and the CSI data from the radio logic 116. The host processor can determine, using the IQ samples and the CSI data, that an environment in which the wireless device 100 is located has been disrupted by a presence or motion of a person. The host processor can determine, using the IQ samples and the CSI data, a presence of a user in proximity to the wireless device 100. The presence can be used for subsequent operations by the device, such as operations of an ambient mode. Radar capability on the existing wireless connectivity solution can provide credible presence and location information with minimal additional costs and creates opportunities for sensor fusion with other modalities. The IQ samples from the radar logic 118 could be a viable alternative for enabling features like ambient and smart modes on low-end devices. Combining the CSI data with the IQ samples can provide increased coverage. The IQ samples and CSI data can be used to distinguish between room-level detection and home-level detection. This integrated radar logic 118 can enable ambient experience on the wireless device 100 without the need for any additional sensors.

In at least one embodiment, the baseband processor 102 sends the set of chirps in the same channel as sending or receiving the first RF signals. In another embodiment, the baseband processor 102 sends the set of chirps in a first channel of a frequency band and sends or receives the first RF signals in a second channel of the frequency band, where the first channel and the second channel are different.

In at least one embodiment, the environment is a home with multiple rooms, and the wireless device 100 is located in a first room of the home. The host processor can determine whether the IQ samples meet a first criterion that the person is present or in motion in the environment. The host processor can determine whether the CSI data meets a second criterion that the person is present or in motion in the environment. The host processor can determine that the person is located in the first room, responsive to the IQ samples meeting the first criterion and the CSI data meeting the second criterion, or the person is located in the home but in a different room, responsive to the IQ samples not meeting the first criterion and the CSI data meeting the second criterion.

In at least one embodiment, the host processor can determine a first indication of whether the person is present or in motion in the environment using the IQ samples. The host processor can determine a second indication of whether the person is present or in motion in the environment using the CSI data. The host processor can determine the presence or motion of the person in the first room responsive to the first indication and the second indication indicating that the person is present or in motion in the environment. The host processor can determine the presence or motion of the person in the home, responsive to only the second indication indicating that the person is present or in motion in the environment.

In at least one embodiment, the radio logic 116 and radar logic 118 are integrated into a Wi-Fi® chipset. In at least one embodiment, the radar logic 118 is a Frequency-Modulated Continuous-Wave (FMCW) radar unit. FMCW is a type of radar system that uses continuous transmission of frequency-modulated signals to detect and measure the distance to objects. The FMCW radar unit generates a continuous waveform known as a “chirp.” A chirp is a signal that continuously changes frequency over time. The frequency of the chirp increases or decreases linearly with time during each transmission. The chirp waveform typically has a frequency sweep bandwidth (B) and a chirp duration (T). The rate of frequency change (slope) is calculated as the ratio of the bandwidth to the chirp duration (Slope=B/T). The FMCW radar unit transmits the chirp signal through the TX antenna 108 into the surrounding environment. The transmitted chirp signal propagates through space and may encounter various objects (targets) along its path. When the chirp signal encounters an object or target, a portion of the signal is reflected back toward the FMCW radar unit. The radar receiver receives the transmitted chirp signal and the reflected signal via the RX antenna 114 and the RX chain 110. The received signals can be mixed with the original transmitted chirp signal. This mixing process can generate a beat frequency, which is the difference between the received and transmitted frequencies. The beat frequency is proportional to the time delay between the transmitted and received signals, which is caused by the round-trip propagation time of the chirp. The beat frequency can be converted into an Intermediate Frequency (IF) signal, which is proportional to the time delay (Δt) between the transmitted and received signals. The time delay (Δt) can be related to the distance (d) to the target through the formula: d=c*Δt/2, where c is the speed of light. By measuring the IF signal or the beat frequency, the radar unit can determine the distance to the target. In some cases, the FMCW radar unit can also detect a Doppler shift caused by moving targets. If a target moves towards or away from the radar, the reflected signal will experience a frequency shift. By analyzing the frequency shift of the reflected signal, the radar unit can determine the velocity of the target relative to the radar unit. The radar logic 118 (FMCW radio) can function in a time-sharing fashion with the radio logic 116. By time-sharing the radar functionality and the radio functionality on the same channel (or a different channel in the frequency band), the host processor can use the CSI data and the presence and localization information to detect a presence of a person and determine a distance to the person for detection and localization applications. The radio logic 116 and radar logic 118 can be implemented in a Wi-Fi® and Radar co-existence protocol that is designed in a way that it does not impact any of the existing Wi-Fi® standards along with Wi-Fi® use-cases. It should be noted that off-the-shelf Wi-Fi® chips do not have dedicated radar functionality. For these chips, only CSI-based sensing is feasible. With the radar logic 118 integrated into the Wi-Fi® chipset, the wireless device 100 can operate in a radar plus CSI mode along with a CSI standalone mode. The inclusions of the radar functionality and sensor fusion algorithms, as described herein, with CSI data, can enable new use cases and improve accuracy of existing use cases.

In at least one embodiment, the wireless device 100 includes a radar unit (e.g., FMCW radar unit), a WLAN radio, and a processing device operatively coupled to the radar unit and the WLAN radio. The processing device can send, using the radar unit via a first antenna, a set of chirps in a first portion of a frame having a specified frame duration. The processing device can receive, using the radar unit via a second antenna, reflected signals corresponding to the set of chirps. The processing device generates IQ samples based on the reflected signals and the set of chirps. The processing device can send or receive, using the WLAN radio to or from a second device via the first antenna or the second antenna, data in a second portion of the frame. The processing device can generate, using RF signals sent or received by the wireless device 100, CSI data representing channel properties of a first channel. The processing device can determine, using the IQ samples and the CSI data, that an environment in which the wireless device is located has been disrupted by a presence or motion of a person. In at least one embodiment, the processing device can send, by the radar unit, the set of chirps in a same channel of a frequency band as sending or receiving the data by the WLAN radio. In at least one embodiment, the processing device can send, by the radar unit, the set of chirps in a first channel of a frequency band, and send or receive, by the WLAN radio, the data in a second channel of the frequency band.

In at least one embodiment, the environment can be a multi-room home and the wireless device 100 is located in a first room of the home. The processing device can determine whether the IQ samples meet a first criterion that the person is present or in motion in the environment and whether the CSI data meets a second criterion that the person is present or in motion in the environment. The processing device can distinguish presence in the first room from presence in the house. In at least one embodiment, the processing device can determine that the person is located in the first room responsive to the IQ samples meeting the first criterion and the CSI data meeting the second criterion or the person is located in the home responsive to the IQ samples not meeting the first criterion and the CSI data meeting the second criterion.

In at least one embodiment, the processing device can apply a first set of parameters to the TX chain 104 and RX chain 110 before sending the set of chirps and receiving the reflected signals. The processing device can apply a second set of parameters to the TX chain and the RX chain before sending or receiving the data. In at least one embodiment, the first set of parameters can include a first parameter that indicates a first transmit power level of the TX chain, and the second set of parameters can include a second parameter that indicates a second transmit power level of the TX chain.

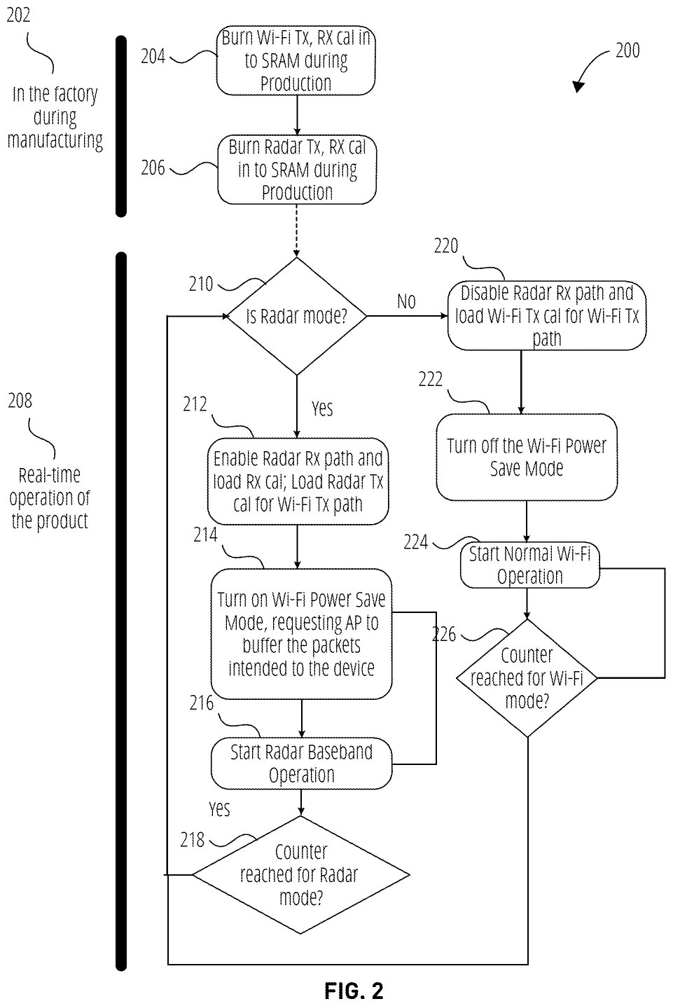

Since the TX chain 104 (and RX chain 110) can be used for both radar and radio transmissions, the baseband processor 102 can store different calibration settings/parameters for the two modes of operation of the TX chain 104 (and RX chain 110). For example, there can be chipset calibration and setup that is required for channelization, calibration, and power-saving modes to enable radar functionality on the existing TX chain 104 used for the radio functionality. Additional details of the calibration and setup are described below with respect to FIG. 2.

FIG. 2 is a flow diagram of a method 200 of operating a baseband processor in a radar mode and a radio mode according to at least one embodiment. The method 200 may be performed by processing logic that may comprise hardware (e.g., circuitry, dedicated logic, programmable logic, microcode, etc.), software (e.g., instructions run on a processing device to perform hardware simulation), or a combination thereof. In one embodiment, the method 200 is performed by the wireless device 100 of FIG. 1. The method 200 can be performed by other devices described herein.

Referring to FIG. 2, the method 200 begins with the processing logic performing operations in a manufacturing phase 202, such as in a factory during manufacturing. In the manufacturing phase 202, the processing logic can store, in a static random access memory (SRAM), a first set of parameters for radio functionality of the RFFE circuitry, such as the Wi-Fi® TX calibration parameters for the TX chain 104 and Wi-Fi® RX calibration parameters for the RX chain 110. The parameters can be determined as a result of calibration and setup of the wireless device 100. In the manufacturing phase 202, the processing logic can also store, in the SRAM, a second set of parameters for radar functionality of the RFFE circuitry.

After the manufacturing phase 202, the processing logic can perform operations in a deployed phase 208, such as real-time operations of the wireless device 100. In the deployed phase 208, the processing logic can determine whether the wireless device 100 is in a radar mode (block 210). When the wireless device 100 is in the radar mode at block 210, the processing logic can enable a radar RX path with the RX chain 110 and a radar TX path with the TX chain 104, loading or applying the second set of parameters into or to the TX chain 104 and the RX chain 110, respectively (block 212). As described above, power levels and corresponding TX and RX calibrations differ for the radio and radar modes. Therefore, factory calibration can be done, and the calibration values can be saved into the SRAM. Depending on the operating mode (e.g., radar mode or radio mode (also labeled as Wi-Fi mode)), the desired calibration parameters are loaded.

In at least one embodiment, the processing logic can turn on a power-saving mode for radio transmissions by requesting an access point (AP) device to buffer incoming packets directed to the wireless device 100 (block 214). Since the wireless device 100 will not be able to transmit or receive Wi-Fi® packets when in the radar mode, the wireless device 100 can perform a handshake operation with an AP for the power-saving mode. This way, the packets intended for the wireless device 100 are buffered by the AP and transmitted when the wireless device 100 is out of the power-saving mode.

At block 216, the processing logic can start radar baseband operations, including collecting IQ samples for detection and localization operations. The processing logic can continue with the baseband operations until a counter for the radar mode is reached (block 218). Once the counter for the radar mode is reached at block 218, the processing logic returns to block 210. Once the wireless device 100 is not in the radar mode at block 210, the processing logic disables the radar RX path and loads the first set of parameters for at least the TX chain 104 for a radio TX path (instead of the radar TX path) (block 220). The processing logic turns off the power-saving mode (block 222). The processing logic starts normal Wi-Fi® operations (block 224). The processing logic continues with the normal Wi-Fi® operations until a counter for a radio mode is reached (block 226). Once the counter for the radio mode is reached at block 226, the processing logic returns to block 210.

In at least one embodiment, the processing logic applies a first set of parameters to the TX chain 104 and the RX chain 110 before sending a set of chirps and receiving reflected signals in the radar mode. The processing logic applies a second set of parameters to the TX chain (and optionally the RX chain 110) before sending and receiving RF signals in the radio mode.

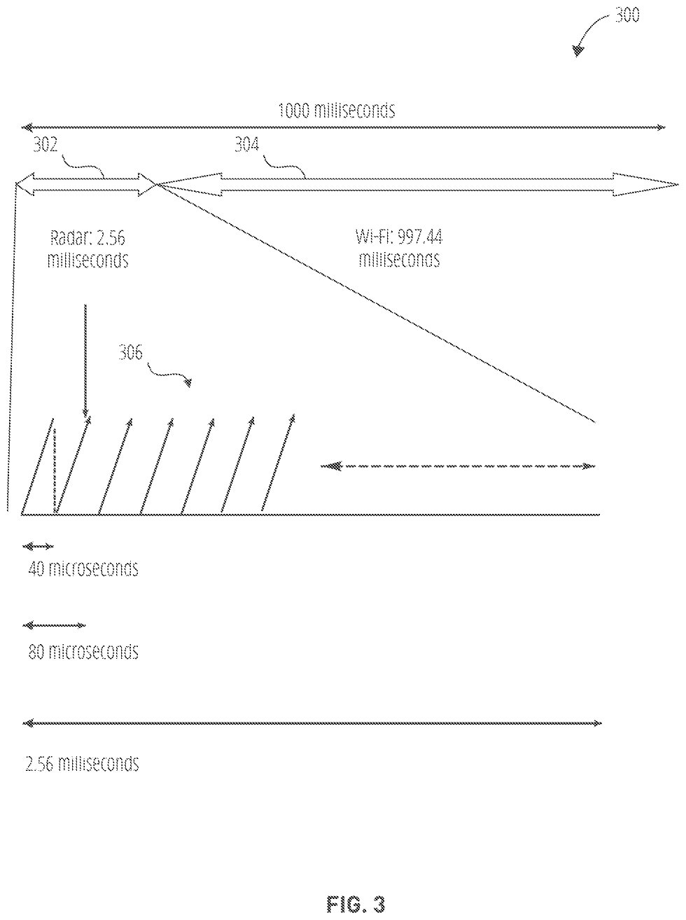

In at least one embodiment, the radar can operate in the 5-6 GHz frequency bands. The wireless device 100 can use the same channel as the home Wi-Fi® network or a different channel in the same band. Alternatively, the wireless device 100 can use different channels in different frequency bands. In at least one embodiment, the same channel can be used for the radar mode and the radio mode to avoid channel switching latency. Since the radio and radar functionalities are time-shared, it is important not to lose any further time that would impact performance. Additional details of the time-division operation are described below with respect to FIG. 3.

FIG. 3 illustrates a frame in which a wireless device switches between a radar mode and a radio mode according to at least one embodiment. As described herein, the radio and radar functionality are operated in a time-division fashion with the radar and radio functionalities sharing the same TX antenna. As illustrated in FIG. 3, the wireless device 100 can transmit a number of chirps 306 (e.g., 32 or 64) in a first portion 302 (e.g., 2.56 milliseconds (ms)) of a frame having a frame duration (e.g., 1000 ms). The wireless device 100 can transmit or receive RF signals in a second portion 304 (e.g., 997.44 ms) of the frame. In some cases, the first portion 302 of the frame duration can lead to poor velocity information but is still adequate for presence detection and localization determinations. The duration of the first portion 302 can be configurable. This parameter can be tuned depending on application requirements. In some cases, since the device may participate in carrier-sense multiple access (CSMA) and random backoff, it can be challenging to use chirps across radar scans for higher Doppler resolution or combining gain. However, if the chirps have a duration of about 40 microseconds and a maximum of 64 (32) chirps in the 2.56 ms interval, the combining gain can be maximized for determining presence and localization information from the set of chirps. As illustrated in FIG. 3, the 64 chirps can be continuously sent without gaps in between each chirp. In at least one embodiment, the wireless device can send at least two chirps of the set of chirps consecutively without a gap between the at least two chirps. In some cases, all 64 chirps are sent consecutively without gaps between the chirps of the set. In other embodiments, there can be a gap between each of the chirps. So, for example, 32 chirps can be sent in the same 2.56 ms interval with a 40 ms gap between each chirp. In other embodiments, different chirp durations and numbers of chirps can be used. In other embodiments, different durations of the first portion 302 and the second portion 304 can be used.

In at least one embodiment, an amount of memory allocated to the radar functionality is 8 Kbytes, and the radar duty cycle is 0.256% (e.g., 256 ms per 1000 ms frame duration). However, the majority of radar design decisions are driven by the Wi-Fi® co-existence and underlying hardware limitations. In other embodiments, the memory allocated or the radar duty cycle can be different values for different applications.

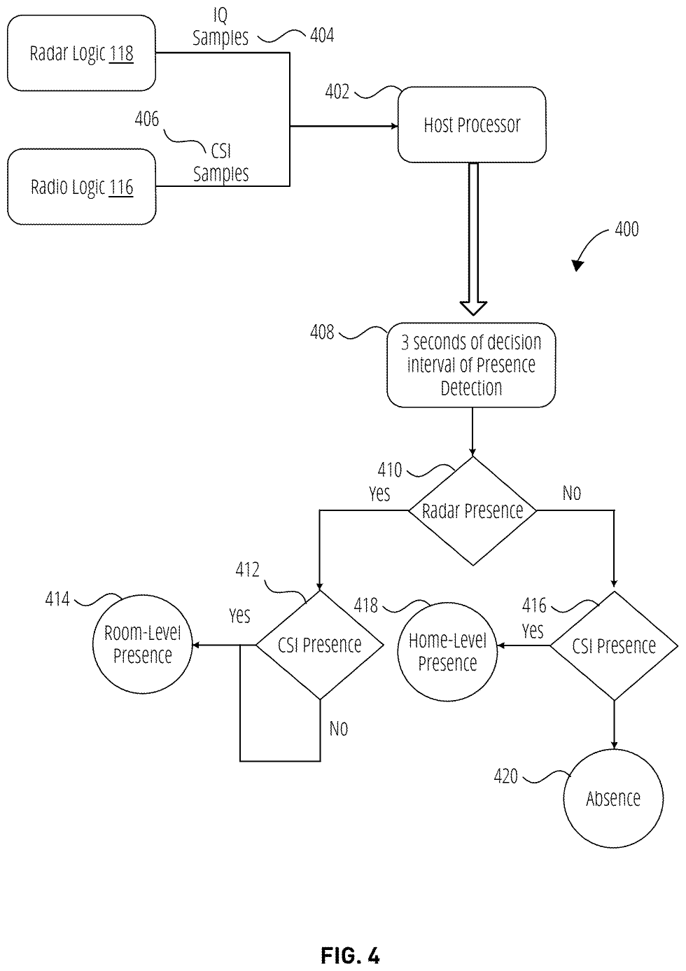

FIG. 4 is a flow diagram illustrating a method by a host processor to collect IQ samples and CSI data for presence detection according to at least one embodiment. The host processor 402 can be coupled to the radar logic 118 and the radio logic 116 of a baseband processor (e.g., baseband processor 102). The functionality of the host processor 402 can alternatively be integrated into the baseband processor and output the presence decisions described below. In the illustrated embodiment, the host processor 402 can receive IQ samples 404 from the radar logic 118 and CSI data 406 (e.g., CSI samples) from the radio logic 116. The host processor 402 can make a determination at a decision interval (e.g., 3 seconds) of presence detection using the IQ samples 404 and CSI data 406 (block 408). The host processor 402 can determine whether the IQ samples 404 indicate a radar presence decision (block 410). The radar presence decision can be whether the IQ samples 404 indicate that the environment in which the wireless device 100 is located has been disrupted by a presence or motion of a person. If so, the host processor 402 can determine whether the CSI data 406 indicates a CSI presence decision (block 412). If so, the host processor 402 can output a room-level presence decision 414. The room-level presence decision 414 can indicate that the person is in the room of the wireless device 100. In this embodiment, if the CSI data 406 does not indicate the CSI presence decision at block 412, the host processor 402 can still output the room-level presence decision 414. In other embodiments, the host processor 402 can indicate that the IQ samples 404 indicate presence, and the CSI data 406 does not indicate presence for further processing or decision-making. In at least one embodiment, multiple thresholds for the radar presence can be used at block 410. If a first threshold is met, the host processor 402 can determine the room-level presence at block 414 without assessing the CSI presence at block 412. If the first threshold is not met, but a second threshold is met for the radar presence at block 410, the host processor 402 can determine whether the CSI presence is met at block 412. If the CSI presence is met at block 412, then the room-level presence is detected at block 414. If the CSI presence is not met at block 412, the host processor 402 could determine that the room-level presence is not met at block 414, but that the home-level presence is met at block 418. In other embodiments, the processing at these operations can output prediction or confidence levels of the detection. Different decisions can be made based on the different prediction or confidence levels determined based on the IQ samples and the CSI data.

If the IQ samples 404 at block 410 indicates no radar presence decision, the host processor 402 can determine whether the CSI data 406 indicates a CSI presence decision (block 416). If so, the host processor 402 can output a home-level presence decision 418. The home-level presence decision 418 can indicate that the person is not in the same room as the wireless device 100 but is present in a home, such as in another room of the home. In this embodiment, if the CSI data 406 does not indicate the CSI presence decision at block 416, the host processor 402 can output an absence decision 420. The absence decision 420 can indicate an absence of a user in the environment, such as the same room as the wireless device 100 or even the home in which the wireless device 100 is located.

In some embodiments, data from both the radar and radio subsystems can be available for the host processor 402 for other post-processing and decision-making operations. The IQ samples 404 and CSI data 406 can be used for other applications, such as heart-rate monitoring, fall activity monitoring, activity detection monitoring, and the like. For these embodiments, the data collection parameters can vary. In at least one embodiment, the CSI data 406 can be sampled at a first sampling frequency (e.g., 100 Hz). In at least one embodiment, the IQ samples 404 can be sampled at a second sampling frequency (e.g., 1 Hz). The IQ samples 404 can be collected over the 2.56 ms with a 1 Hz sampling frequency. In at least one embodiment, the host processor 402 can make the presence decision at a regular interval, such as three seconds. This interval does not impact the enabling a decision at a collected over 2.56 millisecond with a 1 Hz.

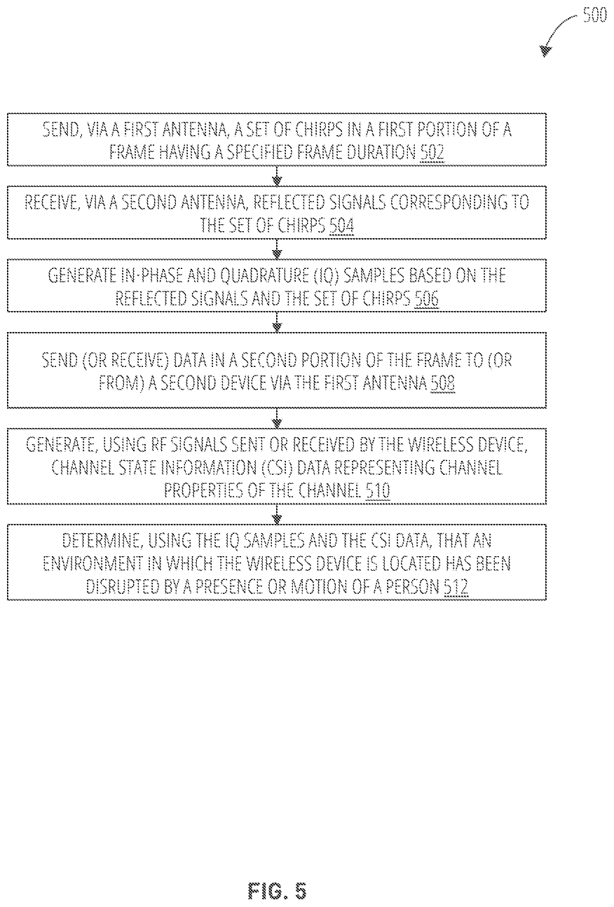

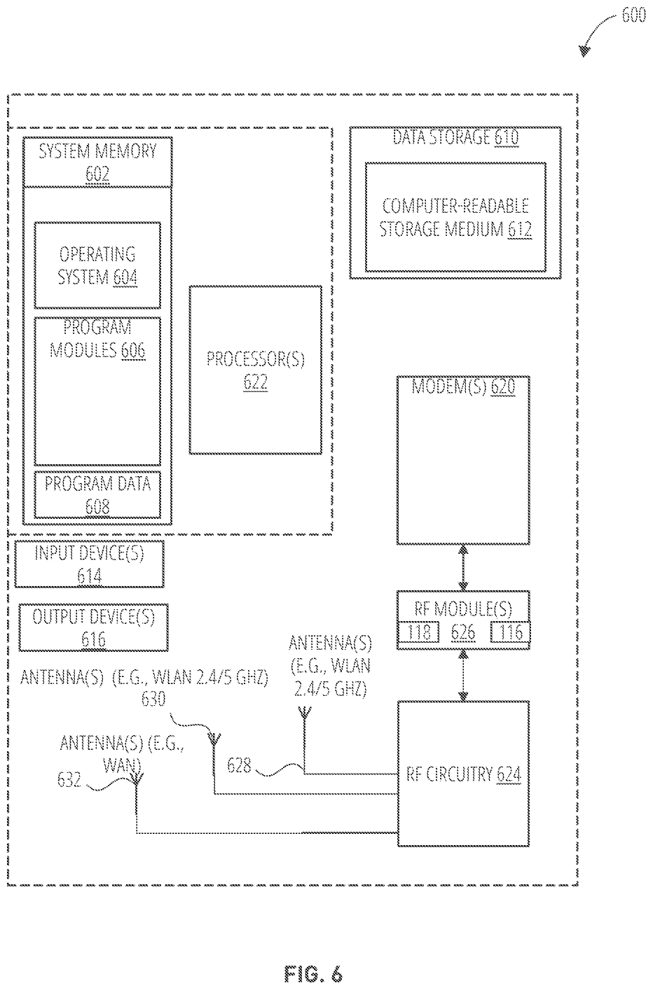

FIG. 5 is a flow chart of a method 500 of detecting a touch or hover event according to at least one embodiment. The method 500 may be performed by processing logic that may comprise hardware (e.g., circuitry, dedicated logic, programmable logic, microcode, etc.), software (e.g., instructions run on a processing device to perform hardware simulation), or a combination thereof. In one embodiment, the method 500 is performed by the wireless device 100 of FIG. 1. In one embodiment, the method 500 is performed by the wireless device 600 of FIG. 6. The method 500 can be performed by other devices described herein.

Referring to FIG. 5, the method 500 begins with the processing logic sending, via a first antenna, a set of chirps in a first portion of a frame having a specified frame duration (block 502). At block 504, the processing logic receives, via a second antenna, reflected signals corresponding to the set of chirps. At block 506, the processing logic generates in-phase and quadrature (IQ) samples based on the reflected signals and the set of chirps. At block 508, the processing logic sends (or receives) data in a second portion of the frame to (or from) a second device via the first antenna (or the second antenna). At block 510, the processing logic generates, using RF signals sent or received by the wireless device, CSI data representing channel properties of the channel. At block 512, the processing logic determines, using the IQ samples and the CSI data, that an environment in which the wireless device is located has been disrupted by a presence or motion of a person.

In at least one embodiment, the processing logic sends the set of chirps at block 502 in a same channel of a frequency band as sending or receiving the data at block 508. In another embodiment, the processing logic sends the set of chirps at block 502 in a first channel of a frequency band and sends or receives the data at block 508 in a second channel of the frequency band. In at least one embodiment, the set of chirps can have N number of chirps, such as 64 chirps. In at least one embodiment, the duration of each chirp can be configurable (e.g., about 40 microseconds). As described herein, before sending the set of chirps at block 502, the processing logic can apply a first set of parameters to a TX chain and/or an RX chain. Before sending or receiving the data at block 508, the processing logic can apply a second set of parameters, different than the first set of parameters, to the TX chain and/or the RX chain. In at least one embodiment, the first set of parameters has a first parameter that indicates a first transmit power level of the TX chain, and the second set of parameters has a second parameter that indicates a second transmit power level of the TX chain. In another embodiment, the first set of parameters includes a first parameter that indicates a first calibration value of a component of the TX chain or the RX chain, and the second set of parameters includes a second parameter that indicates a second calibration value of the component.

In some embodiments, the environment is a home with multiple rooms, and the wireless device is located in a first room of the home. In these embodiments, the processing logic can determine whether the IQ samples meet a first criterion that the person is present or in motion in the environment. The processing logic can determine whether the CSI data meets a second criterion that the person is present or in motion in the environment. The processing logic can distinguish whether the person is located in the first room, the home, or absent from the environment using the IQ samples and the CSI data. In at least one embodiment, the processing logic can determine that the person is located in the first room responsive to the IQ samples meeting the first criterion and the CSI data meeting the second criterion, or that the person is located in the home responsive to the IQ samples not meeting the first criterion and the CSI data meeting the second criterion.

In at least one embodiment, the processing logic can request an AP device to buffer packets destined for or directed to the wireless device. The processing logic can send a request that causes the AP device to buffer the packets directed to the wireless device during a specified time corresponding to the first portion of the frame. This request can be sent in connection with transitioning to the radar mode, as described above. When returning to the radio mode, the processing logic can receive the buffered packets. That is, the processing logic can receive the packets after the first portion of the frame.

FIG. 6 is a block diagram of a wireless device 600 with integrated radio and radar functionality according to one embodiment. The wireless device 600 may correspond to any devices described above with respect to FIG. 1 to FIG. 5. In the depicted embodiment, the wireless device 600 includes the radar logic 118 and radio logic 116. Alternatively, the wireless device 600 may be other electronic devices, as described herein.

The wireless device 600 includes one or more processor(s) 622, such as one or more CPUs, microcontrollers, field-programmable gate arrays, or other types of processors. The wireless device 600 also includes system memory 602, which may correspond to any combination of volatile and/or non-volatile storage mechanisms. The system memory 602 stores information that provides operating system component 604, various program modules 606, program data 608, and/or other components. In one embodiment, the system memory 602 stores instructions of methods to control the operation of the wireless device 600. The wireless device 600 performs functions by using the processor(s) 622 to execute instructions provided by the system memory 602.

The wireless device 600 also includes a data storage device 610 that may be composed of one or more types of removable storage and/or one or more types of non-removable storage. The data storage device 610 includes a computer-readable storage medium 612 on which is stored one or more sets of instructions embodying any of the methodologies or functions described herein. Instructions for the program modules 606 may reside, completely or at least partially, within the computer-readable storage medium 612, system memory 602, and/or within the processor(s) 622 during execution thereof by the wireless device 600, the system memory 602 and the processor(s) 622 also constituting computer-readable media. The wireless device 600 may also include one or more input device(s) 614 (keyboard, mouse device, specialized selection keys, etc.) and one or more 616 (displays, printers, audio output mechanisms, etc.).

The wireless device 600 further includes one or more modem(s) 620 to allow the wireless device 600 to communicate via wireless connections (e.g., such as provided by the wireless communication system) with other computing devices, such as remote computers, an item providing system, and so forth. The modem(s) 620 can be connected to one or more radio frequency (RF) modules 626. The RF modules 626 may be a WLAN module, a WAN module, a wireless personal area network (WPAN) module, a Global Positioning System (GPS) module, or the like. The antenna structures (antenna(s) 628, 630, 632) are coupled to the RF circuitry 624, which is coupled to the modem(s) 62020. The RF circuitry 624 may include radio front-end circuitry, antenna switching circuitry, impedance matching circuitry, or the like. The antenna(s) 628, 630, 632 may be GPS antennas, near field communication (NFC) antennas, other WAN antennas, WLAN or PAN antennas, or the like. The modem(s) 620 allows the wireless device 60000 to handle both voice and non-voice communications (such as communications for text messages, multimedia messages, media downloads, web browsing, etc.) with a wireless communication system. The modem(s) 620 may provide network connectivity using any type of mobile network technology including, for example, cellular digital packet data (CDPD), general packet radio service (GPRS), EDGE, universal mobile telecommunications system (UMTS), 1 times radio transmission technology (1×RTT), evaluation data optimized (EVDO), high-speed downlink packet access (HSDPA), Wi-Fi®, Long Term Evolution (LTE) and LTE Advanced (sometimes generally referred to as 4G), etc.

The modem(s) 620 may generate signals and send these signals to the antenna(s) 628 of a first type (e.g., WLAN 5 GHZ), antenna(s) 630 of a second type (e.g., WLAN 2.4 GHZ), and/or antenna(s) 632 of a third type (e.g., WAN), via RF circuitry 624, and RF module(s) 626 as described herein. Antenna(s) 628, 630, 632 may be configured to transmit in different frequency bands and/or using different wireless communication protocols. The antenna(s) 628, 630, 632 may be directional, omnidirectional, or non-directional antennas. In addition to sending data, antenna(s) 628, 630, 632 may also receive data, which is sent to appropriate RF modules connected to the antennas. One of the antenna(s) 628, 630, 632 may be any combination of the antenna structures described herein.

In one embodiment, the wireless device 600 establishes a first connection using a first wireless communication protocol, and a second connection using a different wireless communication protocol. The first wireless connection and second wireless connection may be active concurrently, for example, if a wireless device is receiving a media item from another wireless device (e.g., a mini-POP node) via the first connection) and transferring a file to another electronic device (e.g., via the second connection) at the same time. Alternatively, the two connections may be active concurrently during wireless communications with multiple devices. In one embodiment, the first wireless connection is associated with a first resonant mode of an antenna structure that operates at a first frequency band and the second wireless connection is associated with a second resonant mode of the antenna structure that operates at a second frequency band. In another embodiment, the first wireless connection is associated with a first antenna structure and the second wireless connection is associated with a second antenna. In other embodiments, the first wireless connection may be associated with content distribution within mesh nodes of a wireless mesh network and the second wireless connection may be associated with serving a content file to a client consumption device, as described herein.

In the above description, numerous details are set forth. It will be apparent, however, to one of ordinary skill in the art having the benefit of this disclosure, that embodiments may be practiced without these specific details. In some instances, well-known structures and devices are shown in block diagram form rather than in detail in order to avoid obscuring the description.

Some portions of the detailed description are presented in terms of algorithms and symbolic representations of operations on data bits within a computer memory. These algorithmic descriptions and representations are the means used by those skilled in the data processing arts to convey the substance of their work most effectively to others skilled in the art. An algorithm is used herein and is generally conceived to be a self-consistent sequence of steps leading to the desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “determining,” “sending,” “receiving,” “scheduling,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments also relate to an apparatus for performing the operations herein. This apparatus may be specially constructed for the required purposes, or it may comprise a general-purpose computer selectively activated or reconfigured by a computer program stored in the computer. Such a computer program may be stored in a computer-readable storage medium, such as, but not limited to, any type of disk including floppy disks, optical disks, Read-Only Memories (ROMs), compact disc ROMs (CD-ROMs), and magnetic-optical disks, Random Access Memories (RAMs), EPROMS, EEPROMs, magnetic or optical cards, or any type of media suitable for storing electronic instructions.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present embodiments are not described with reference to any particular programming language. It will be appreciated that a variety of programming languages may be used to implement the teachings of the present embodiments as described herein. It should also be noted that the terms “when” or the phrase “in response to,” as used herein, should be understood to indicate that there may be intervening time, intervening events, or both before the identified operation is performed.

It is to be understood that the above description is intended to be illustrative, and not restrictive. Many other embodiments will be apparent to those of skill in the art upon reading and understanding the above description. The scope of the present embodiments should, therefore, be determined with reference to the appended claims, along with the full scope of equivalents to which such claims are entitled.

What is claimed is:

1. A wireless device comprising:
a first antenna;
a second antenna;
a processing device;
a baseband processor coupled to the processing device, the first antenna, and the second antenna, wherein the baseband processor establishes a wireless connection with a second wireless device over a first channel, wherein the baseband processor comprises a radar unit;
radio frequency front-end (RFFE) circuitry comprising a transmit (TX) chain coupled to the first antenna and a receive (RX) chain coupled to the second antenna, wherein:
the baseband processor:
sends, via the TX chain, a set of chirps in a first portion of a frame having a specified frame duration;
receives, via the RX chain, reflected signals corresponding to the set of chirps;
generates in-phase and quadrature (IQ) samples based on the reflected signals and the set of chirps;
sends or receives, via the TX chain or RX chain, first RF signals in a second portion of the frame; and
generates channel state information (CSI) data representing channel properties of the first channel based on second RF signals sent or received by the RFFE circuitry during a specified interval, wherein the second RF signals comprises at least the first RF signals;
the processing device:
receives the IQ samples and the CSI data from the baseband processor; and
determines, using the IQ samples and the CSI data, that an environment in which the wireless device is located has been disrupted by a presence or motion of a person.

2. The wireless device of claim 1, wherein the environment is a home with multiple rooms, wherein the wireless device is located in a first room of the home, wherein the processing device:
determining whether the IQ samples meet a first criterion that the person is present or in motion in the environment;
determining whether the CSI data meets a second criterion that the person is present or in motion in the environment; and
determining that the person is located in the first room responsive to the IQ samples meeting the first criterion and the CSI data meeting the second criterion; or
determining that the person is located in the home responsive to the IQ samples not meeting the first criterion and the CSI data meeting the second criterion.

3. A method of operating a wireless device, the method comprising:
sending, via a first antenna, a set of chirps in a first portion of a frame having a specified frame duration;
receiving, via a second antenna, reflected signals corresponding to the set of chirps;
generating in-phase and quadrature (IQ) samples based on the reflected signals and the set of chirps;
sending data to a second device via the first antenna, the data included in a second portion of the frame;
generating, using RF signals sent or received by the wireless device, channel state information (CSI) data representing channel properties of a first channel; and
determining, using the IQ samples and the CSI data, that an environment in which the wireless device is located has been disrupted by a presence or motion of a person.

4. The method of claim 3, wherein sending the set of chirps comprises sending the set of chirps in a same channel of a frequency band as sending the data.

5. The method of claim 3, wherein sending the set of chirps comprises sending the set of chirps in a second channel of a frequency band, wherein sending the data comprises sending the data in the first channel of the frequency band.

6. The method of claim 3, wherein the environment is a home with multiple rooms, wherein the wireless device is located in a first room of the home, wherein the method further comprises:
determining that the IQ samples meet a first criterion, the first criterion indicative of the person being present or in motion in the environment;
determining that the CSI data meets a second criterion, the second criterion indicative of the person being present or in motion in the environment; and
determining that the person is located in the first room responsive to the IQ samples meeting the first criterion and the CSI data meeting the second criterion; or
determining that the person is located in the home responsive to the IQ samples not meeting the first criterion and the CSI data meeting the second criterion.

7. The method of claim 3, wherein the set of chirps comprises 64 chirps or less, each having a duration of about 40 microseconds.

8. The method of claim 3, wherein sending the set of chirps comprises sending at least two chirps consecutively without a gap between the at least two chirps.

9. The method of claim 3, further comprising:
applying a first set of parameters to a transmit (TX) chain and a receive (RX) chain of the wireless device before sending the set of chirps and receiving the reflected signals; and
applying a second set of parameters to the TX chain and the RX chain before sending the data.

10. The method of claim 9, wherein the first set of parameters comprises a first parameter that indicates a first transmit power level of the TX chain, and wherein the second set of parameters comprises a second parameter that indicates a second transmit power level of the TX chain.

11. The method of claim 9, wherein the first set of parameters comprises a first parameter that indicates a first calibration value of a component of the TX chain or the RX chain, and wherein the second set of parameters comprises a second parameter that indicates a second calibration value of the component.

12. The method of claim 3, further comprising:
sending a request to an access point (AP) device, the request causes the AP device to buffer packets directed to the wireless device and received by the AP device during the first portion of the frame; and
receiving the packets after the first portion of the frame.

13. A wireless device comprising:
a radar unit;
a wireless local area network (WLAN) radio; and
a processing device operatively coupled to the radar unit and the WLAN radio, wherein the processing device is to:
send, using the radar unit via a first antenna, a set of chirps in a first portion of a frame having a specified frame duration;
receive, using the radar unit via a second antenna, reflected signals corresponding to the set of chirps;
generate in-phase and quadrature (IQ) samples based on the reflected signals and the set of chirps;
send, using the WLAN radio, data to a second device via the first antenna, the data included in a second portion of the frame;
generate, using RF signals sent or received by the wireless device, channel state information (CSI) data representing channel properties of a first channel; and
determine, using the IQ samples and the CSI data, that an environment in which the wireless device is located has been disrupted by a presence or motion of a person.

14. The wireless device of claim 13, wherein the processing device is to send the set of chirps in a same channel of a frequency band as sending the data.

15. The wireless device of claim 13, wherein the processing device is to send the set of chirps in a second channel of a frequency band, wherein the processing device is to send the data in the first channel of the frequency band.

16. The wireless device of claim 13, wherein the environment is a home with multiple rooms, wherein the wireless device is located in a first room of the home, wherein the processing device is further to:
determine that the IQ samples meet a first criterion, the first criterion indicative of the person being present or in motion in the environment;
determine that the CSI data meets a second criterion, the second criterion indicative of the person being present or in motion in the environment; and
determine that the person is located in the first room responsive to the IQ samples meeting the first criterion and the CSI data meeting the second criterion; or
determine that the person is located in the home responsive to the IQ samples not meeting the first criterion and the CSI data meeting the second criterion.

17. The wireless device of claim 13, wherein the set of chirps comprises 64 chirps or less, each having a duration of about 40 microseconds.

18. The wireless device of claim 13, wherein the processing device is to send at least two chirps of the set of chirps consecutively without a gap between the at least two chirps.

19. The wireless device of claim 13, wherein the processing device is further to:
apply a first set of parameters to a transmit (TX) chain and a receive (RX) chain of the wireless device before sending the set of chirps and receiving the reflected signals; and
apply a second set of parameters to the TX chain and the RX chain before sending the data.

20. The wireless device of claim 19, wherein the first set of parameters comprises a first parameter that indicates a first transmit power level of the TX chain, and wherein the second set of parameters comprises a second parameter that indicates a second transmit power level of the TX chain.
